(19) United States
(12) Patent Application Publication
(10) Pub. No.: US 2013/0312780 A1
(43) Pub. Date: Nov. 28, 2013

(54) Hair Treatment Apparatus

(71) Applicants: Dolev Rafaeli, Cresskill, NY (US); Philip Solomon, Kibbutz Tzora (IL)

(72) Inventors: Dolev Rafaeli, Cresskill, NY (US); Philip Solomon, Kibbutz Tzora (IL)

(73) Assignee: RADIANCY INC., Orangeburg, NY (US)

(21) Appl. No.: 13/983,567

(22) PCT Filed: Feb. 20, 2012
(86) PCT No.: PCT/IL2012/050055

§ 371 Date: Aug. 4, 2013

Related U.S. Application Data
(60) Provisional application No. 61/444,755, filed on Feb. 20, 2011.

(51) Int. Cl. A45D 24/30

(52) U.S. Cl. CPC A45D 24/30
USPC 132/200; 132/118

(57) ABSTRACT

A treatment apparatus for hair constituted of: a comb like assembly constituted of a base member and a plurality of teeth extending from the base member; a motion sensor fixed in relation to the comb like assembly and arranged to output a signal indicative of motion of the comb like assembly; a control circuitry in communication with the motion sensor; and a heat source arranged to provide heat to hair strands disposed between the plurality of teeth of the comb like assembly, wherein the control circuitry is arranged to interrupt the heat source in the absence of motion of the comb like assembly.

### CROSS-REFERENCE TO RELATED APPLICATIONS

This application claims priority from U.S. Provisional Patent Application Ser. No. 61/444,755, filed Feb. 20, 2011, entitled “HAIR TREATMENT APPARATUS”, the entire contents of which are incorporated herein by reference.

### TECHNICAL FIELD

The present invention relates generally to treating insect infestations, and specifically to methods and apparatus for exterminating lice infestations.

### BACKGROUND

Human pediculosis is the infestation of the human scalp, body or pubic area with lice. Head lice lay eggs, also known as nits, on the hair of the head, which hatch into nymphs and the nymphs ultimately mature into adult lice. Lice infestations are conventionally treated with chemicals, such as shampoos, lotions, and creams containing various insecticides such as lindane, malathion, or permethrin, which generally kill the lice, but disadvantageously do not kill the eggs. Thus, following treatment with these chemicals, the eggs must be manually removed by careful examination of the affected area. In order for chemical treatment to be effective, it generally must be repeated at least once in order to exterminate any lice which have hatched from eggs overlooked during the manual egg removal. It has been noted that lice are increasingly developing resistance to commonly used chemicals, thus decreasing the effectiveness of the above treatment method. Furthermore, placing chemicals in one's hair is potentially dangerous and undesired.

To overcome the difficultly of manually removing lice and nits numerous lice combs have been developed, including combs with finely spaced tines, and combs with teeth having particular shapes, e.g. combs which widen at the base or exhibit diamond shaped teeth. Some combs incorporate a magnifying glass to aid in finding nits. Disadvantageously, live lice combed off the hair can travel and infect a different person or return to the treated head after combing. One solution to this problem is provided by incorporating in the comb an adhesive strip, adhesive spots or a receptacle to trap the lice. Unfortunately, these can be cumbersome and can require frequent replacement and/or emptying thereof.

Another solution is to kill the lice during combing. U.S. Pat. No. 5,628,332 issued May 13, 1997 to Debourg et al., the entire contents of which is incorporated by reference, is addressed to a comb with heated teeth at a temperature of at least 60° C., thereby killing the lice and nits which come in contact with the teeth. Disadvantageously, the comb of Debourg will singe the hair, or scalp, if left in a stationary position for a certain amount of time, and therefore the use of a higher temperature which may more expeditiously delouse the affected area is prevented. Additionally, in order not to singe the scalp, the comb of Debourg is arranged such that the heated teeth are detached from the scalp by at least several tenths of a millimeter. Unfortunately, nits are located extremely close to the scalp, thus destruction of nits is limited.

U.S. Pat. No. 5,261,427 to Dolev is addressed to a comb exhibiting a device for blowing hot air through the teeth of the comb, thereby killing nits and lice. In order to avoid burning of the scalp, Dolev provides deflectors arranged to deflect the hot air away from the scalp and towards the base of the hair and thus adds an additional structure to the comb and can make combing difficult.

There is thus a long felt need for a treatment apparatus exhibiting an efficient and safe way to kill and remove lice and nits from hair or fur.

### SUMMARY

Accordingly, it is a principal object to overcome at least some of the disadvantages of prior art devices for removing infestations of lice from hair or fur. This is accomplished in certain embodiments by a treatment apparatus comprising a comb for removing lice and nits from the hair, a heat source arranged to kill the lice and nits during combing and a motion sensor arranged to detect motion of the comb. When substantially no motion is detected by the motion sensor, the output of heat from the heat source is interrupted. In one embodiment, the speed of motion of the comb is further detected. The temperature of the heat output of the heat source is adjusted responsive to the detected speed of motion of the comb. Thus, in the presence of detected motion, increased heat may be supplied, as compared to the prior art, resulting in improved removal of infestations, while protecting the hair or fur from undesired singeing.

In one independent embodiment, a treatment apparatus for hair is provided, the treatment apparatus comprises: a comb like assembly comprising a base member and a plurality of teeth extending from the base member; a motion sensor fixed in relation to the comb like assembly and arranged to output a signal indicative of motion of the comb like assembly; a control circuitry in communication with the motion sensor; and a heat source arranged to provide heat to hair strands disposed between the plurality of teeth of the comb like assembly, wherein the control circuitry is arranged to interrupt the heat source in the absence of motion of the comb like assembly.

In one embodiment, the heat source comprises an element arranged to provide the heat to the hair strands, the element heated to a temperature of between 60 degrees Centigrade and 250 degrees Centigrade. In another embodiment, the heat source comprises an element which exhibits a heat capacity of less than 1 Joule per Kelvin. In one embodiment, the heat source comprises an element which exhibits a heat capacity of 0.5-1 Joule per Kelvin.

In one further embodiment, the element is an elongate element secured to the base member. In another further embodiment, the element is an elongate element secured to the base member and arranged to proceed generally orthogonally to the extension of the plurality of teeth.

In one further embodiment, the element is secured to the plurality of teeth. In another further embodiment, the heat source comprises a plurality of the elements, secured along a side of alternate ones of the plurality of teeth. In one further embodiment, the element is secured along a side of each of the plurality of teeth.

In one embodiment, the heat source comprises an infrared lamp secured in relation to the base member. In one further embodiment, the infrared lamp is arranged to output light exhibiting wavelengths of 700-3000 nanometers. In another further embodiment, the plurality of teeth are curved to a generally concave shape.

In one further embodiment, the plurality of teeth exhibit a pitch so as to provide only an individual hair strand disposed between adjacent teeth of the comb like assembly in proximity of the base member. In another further embodiment, the treatment apparatus further comprises a roller in a fixed relationship to the base member, the roller comprising a plurality of radially extending projections arranged to draw the hair strands to be in proximity to the roller when the roller is rotated about a central longitudinal axis thereof.

In one yet further embodiment, the treatment apparatus comprises a motor in communication with the roller, and arranged to rotate the roller about the central longitudinal axis thereof. In one yet even further embodiment, the motor is responsive to the control circuitry, the control circuitry arranged to control the motor to rotate the roller so that the outer circumference of the roller exhibits a linear speed greater than the speed of motion detected by the motion sensor.

In one further embodiment, the motion sensor is further arranged to output a signal indicative of the speed of motion of the comb like assembly and wherein the control circuitry is further arranged to: in the event the speed of motion of the comb like assembly increases, raise the temperature of the heat output of the heat source; and in the event the speed of motion of the comb like assembly decreases, lower the temperature of the heat output of the heat source.

In another independent embodiment, a method of treating an infested hair portion is provided, the method comprising: providing a comb like assembly comprising a base member and a plurality of teeth extending from the base member; sensing motion of the provided comb like assembly; heating hair strands disposed between the plurality of teeth of the provided comb like assembly; and interrupting the heating in the absence of the sensed motion.

In one embodiment, the heating hair strands comprises: providing an element; and heating the provided element to a temperature of between 60 degrees Centigrade and 250 degrees Centigrade. In one further embodiment, the provided element exhibits a heat capacity of less than 1 Joule per Kelvin. In another further embodiment, the provided element exhibits a heat capacity of 0.5-1 Joule per Kelvin.

In one further embodiment, the provided element is an elongate element secured along a side of at least one of the plurality of teeth. In another further embodiment, the provided element is an elongate element secured to the base member.

In another embodiment, the method further comprises: providing an infrared lamp, wherein the heating hair strands is responsive to the provided infrared lamp. In one further embodiment, the heating hair strands comprises outputting light from the provided infrared lamp, the output light exhibiting wavelengths of 700-3000 nanometers.

In one embodiment, the plurality of teeth exhibit a pitch so as to provide only an individual hair strand disposed between adjacent teeth of the comb like assembly in proximity of the base member. In another embodiment, the method further comprises: providing a roller comprising a plurality of radially extending projections; and drawing the hair strands to be in proximity of the provided roller by rotating the provided roller about a central longitudinal axis thereof.

In one further embodiment, the rotating is at a speed such that the outer circumference of the provided roller exhibits a linear speed greater than the sensed motion of the provided comb like assembly. In one embodiment, the method further comprises: sensing the speed of motion of the provided comb like assembly; in the event the speed of motion of the comb like assembly increases, raising the temperature of the heating; and in the event the speed of motion of the comb like assembly decreases, lowering the temperature of the heating.

Additional features and advantages will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1A illustrates a perspective view of a first embodiment of a treatment apparatus for hair in accordance with certain embodiments;

FIG. 1B illustrates a high level schematic diagram of a control unit for controlling the treatment apparatus of FIG. 1A;

FIG. 2A illustrates a perspective view of a second embodiment of a treatment apparatus for hair in accordance with certain embodiments;

FIG. 2B illustrates an exploded perspective view of a portion of the second embodiment of a treatment apparatus for hair of FIG. 2A;

FIG. 3A illustrates a perspective view of a third embodiment of a treatment apparatus for hair in accordance with certain embodiments;

FIG. 3B illustrates a high level schematic diagram of a control unit for controlling the treatment apparatus of FIG. 3A;

FIG. 4 illustrates a perspective view of a fourth embodiment of a treatment apparatus for hair in accordance with certain embodiments;

FIG. 5 illustrates a perspective view of a fifth embodiment of a treatment apparatus for hair in accordance with certain embodiments;

FIG. 6 illustrates a perspective view of a sixth embodiment of a treatment apparatus for hair in accordance with certain embodiments;

FIG. 7 illustrates a high level flow chart of a first embodiment of a method for hair treatment; and

FIG. 8 illustrates a high level flow chart of a second embodiment of a method for hair treatment.

### DETAILED DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

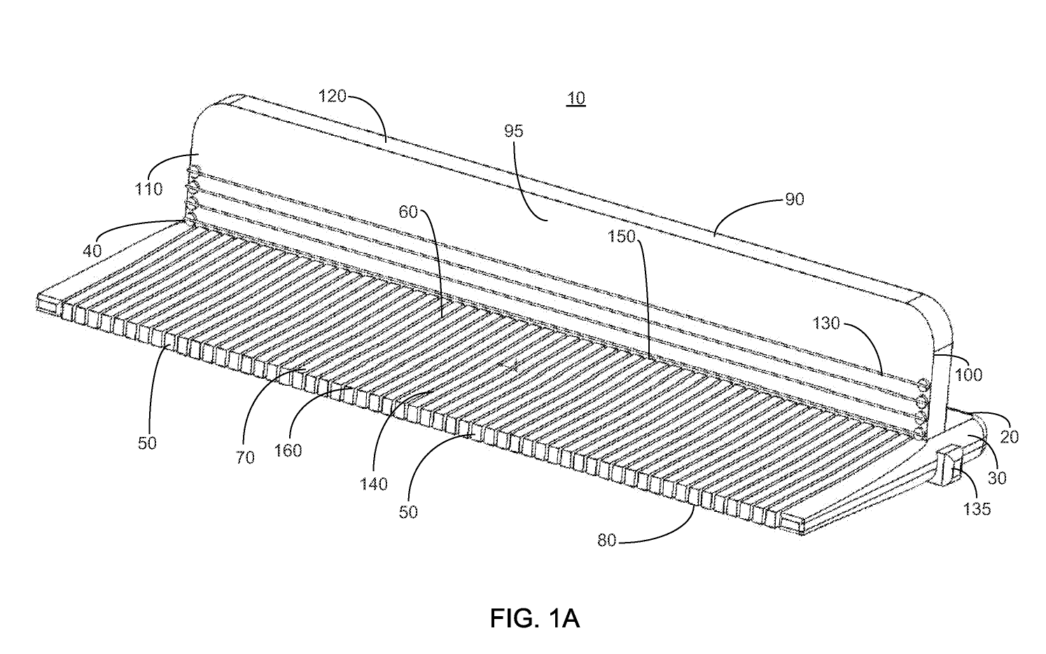

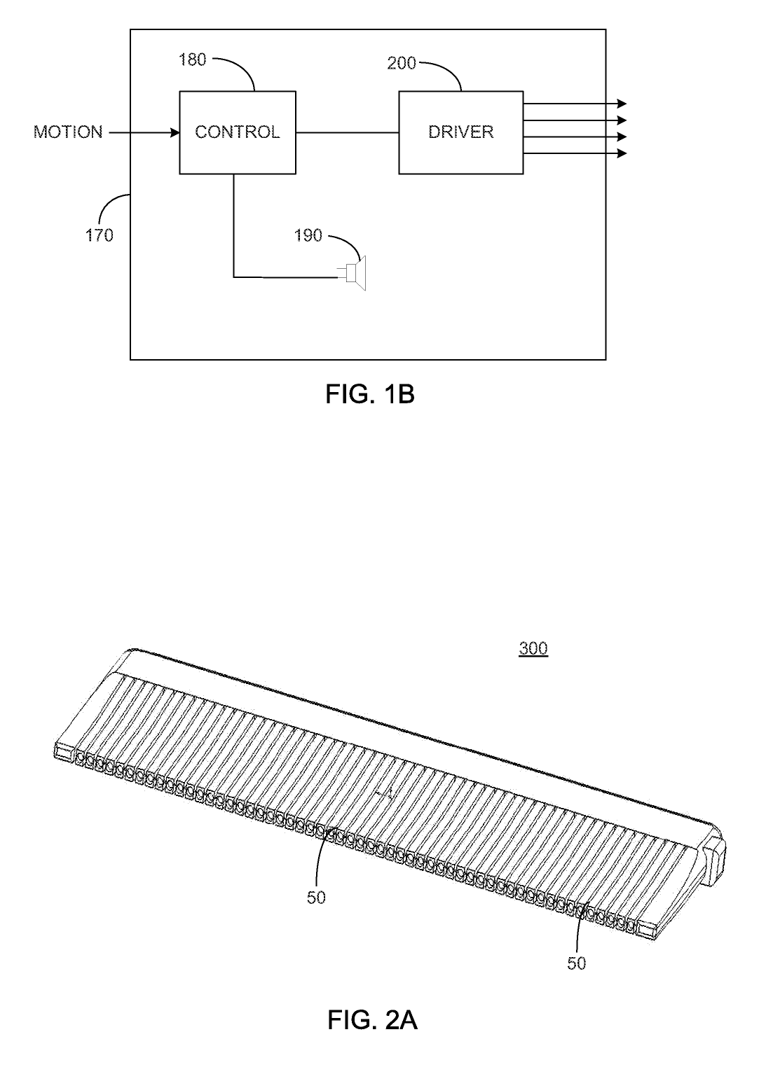

FIG. 1A illustrates a perspective view of a treatment apparatus 10 for hair, comprising: a base member 20, extending from a first end 30 to a second end 40; a plurality of teeth 50 extending longitudinally from a proximal end 60 of the respective tooth 50 which is connected to base member 20 to a distal end 70 and generally defining a plane 80; a protruding member 90, extending from a first end 100 to a second end 110 and exhibiting a face 95, protruding member 90 extending longitudinally from base member 20 and generally defining a plane 120 generally orthogonal to plane 80; a plurality of elongate elements 130 extending across face 95 of protruding member 90 from first end 100 to second end 110; and a motion sensor 135.

Plurality of teeth 50 are disposed across base member 20 from first end 30 to second end 40, thereby forming a comb like assembly. Each adjacent pair of teeth 50 defines a space 140, a proximal end 150 of each space 140 defined by the space between proximal ends 60 of the respective adjacent pair of teeth 50 and a distal end 160 of each space 140 defined by the space between distal ends 70 of the respective adjacent pair of teeth 50. In one embodiment, plurality of teeth 50 are evenly spaced, i.e. spaces 140 are substantially equal. In one embodiment, the pitch of plurality of teeth 50 is arranged such that proximal end 150 of each space 140 is narrow enough to allow entry of only one hair strand at a time therein. In one embodiment, proximal end 150 of each space 140 is no more than ⅓ mm wide.

First end 100 of protruding member 90 is connected to first end 30 of base member 20 and second end 110 of protruding member 90 is connected to second end 40 of base member 20. In one embodiment, plurality of elongate elements 130 are evenly spaced along a portion of face 95 adjacent proximal ends 60 of teeth 50. Each of the plurality of elongate elements 130 are composed of an electrically conductive material and are arranged to produce heat with temperatures between 60°-250° C. responsive to an electric current flowing therethrough. In one embodiment, each of the plurality of elongate elements 130 exhibits a low heat capacity, allowing for rapid cooling. In one embodiment, each elongate element 130 exhibits a heat capacity of less than 1 J/K. In one further embodiment, each elongate element 130 exhibits a heat capacity of between 0.5-1 J/K. In one embodiment, each elongate element exhibits a cross-section with a diameter of less than 0.5 mm and in one further embodiment each elongate element exhibits a cross-section with a diameter of 0.08-0.5 mm. Four elongate elements 130 are illustrated, however this is not meant to be limiting in any way and any number of elongate elements 130 may be provided without exceeding the scope. In one embodiment, only one elongate element 130 is provided. In one embodiment, motion sensor 135 comprises any of a plurality of standard motion sensors, including, but not limited to: optical sensors; magnetic sensors; and ultrasonic sensors. In one embodiment, motion sensor 135 is placed anywhere on treatment apparatus 10.

FIG. 1B illustrates a high level schematic diagram of a control unit 170, comprising: a control circuitry 180; an alarm 190; and a driver 200. In one embodiment, alarm 190 comprises an audible alarm. In another embodiment, alarm 190 comprises a visual alarm, such as an LED. An output of motion sensor 135 is connected to an input of control circuitry 180. An input of alarm 190 is connected to a first output of control circuitry 180. An input of driver 200 is connected to a second output of control circuitry 180 and each of a plurality of outputs of driver 200 is connected to a particular elongate element 130. In one embodiment (not shown), driver 200 is provided as a plurality of drivers 200, each associated with a particular elongate element 130, the input of each driver 200 connected to a respective output of control circuitry 180 and the output of each driver 200 connected to the associated elongate element 130. In one embodiment, control unit 170 is placed internal of treatment apparatus 10. For the sake of clarity, the operation of FIGS. 1A and 1B will be described together.

In operation, control circuitry 180 provides a current through the plurality of elongate elements 130 via driver 200, thereby heating up the plurality of elongate elements 130 to a temperature of between 60°-250° C. A user combs their hair with the comb like assembly of treatment apparatus 10. As the user combs, hair strands enter respective spaces 140 at distal ends 160. As a hair strand passes through proximal end 150 of the respective space 140, heat from the plurality of elongate elements 130 is radiated to the hair strand, and/or the hair strand may come in contact with one or more of the plurality of elongate elements 130. In one embodiment, the heat applied to the hair exhibits an energy of 2-20 J/cm². Lice and nits clinging to the hair strand and the scalp area surrounding the hair strand are killed by the radiated, or conducted, heat. The killed lice and nits are then removed by the comb like assembly during motion of treatment apparatus 10. The plurality of elongate elements 130 allows heat to be evenly applied along the length of the hair strand, as the hair strands caught in spaces 140 rise parallel to plane 120. Much less heat is required to kill lice and nits than to singe hair, therefore the hair is not singed as long as treatment apparatus 10 is kept in motion.

Motion sensor 135 is arranged to detect motion of treatment apparatus 10. In the event the user ceases movement of treatment apparatus 10, motion sensor 135 outputs a signal to control circuitry 180. In one embodiment, alarm 190 indicates that motion has stopped. Responsive to the received signal, control circuitry 180 stops current from flowing through the plurality of elongate elements 130, thereby ceasing the heating of the elongate elements 130, and due to the their low heat capacity rapidly removing any heat radiation and ensuring that hair strands aren't singed. In one embodiment, motion sensor 135 is further arranged to detect the speed at which treatment apparatus 10 is moving at. As the speed increases, control circuitry 180 controls driver 200 to increase the current flowing through elongate elements 130, thereby raising the temperature of the heat output by elongate elements 130, thereby improving the effectiveness of treatment while preventing the singeing of hair. As the speed decreases, control circuitry 180 controls driver 200 to decrease the current flowing through elongate elements 130, thereby lowering the temperature of the heat output by elongate elements 130 in order to avoid singeing of the hair strands. As indicated above, lice and nits are killed quicker when exposed to greater temperatures; however the risk of singeing the hair rises with the rise of temperature. Advantageously, the detection of the speed of treatment apparatus 10 allows ideal control of the temperature of the heat output by the plurality of elongate elements 130 to maximize efficiency of lice killing, while avoiding any injury to the hair or scalp. In one embodiment, when the speed of motion of treatment apparatus 10 is lower than a predetermined speed, current flow through the plurality of elongate elements 130 is ceased, as described above.

The above has been described where treatment apparatus 10 is used for killing and removing lice and nits from human hair, however this is not meant to be limiting in any way. In another embodiment, treatment apparatus 10 can be used for killing and removing lice, fleas and other pests from animal fur.

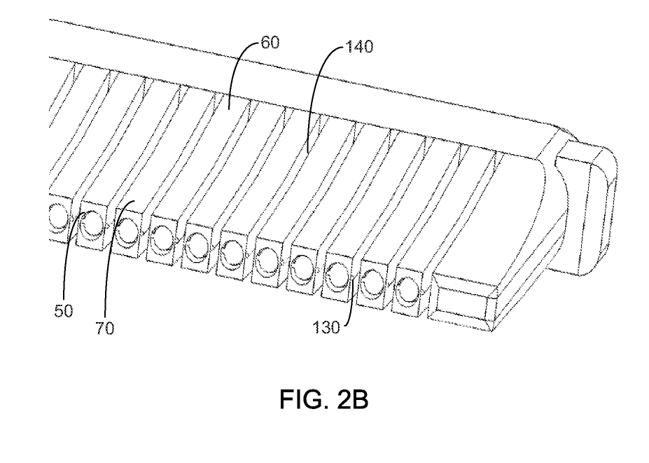

FIG. 2A illustrates a perspective view of a treatment apparatus 300 for hair and FIG. 2B illustrates an exploded perspective view of a portion of treatment apparatus 300. Treatment apparatus 300 is in all respects similar to treatment apparatus 10 of FIG. 1, with the exception that protruding member 90 is not provided. In one embodiment, each space 140 comprises a pair of elongate elements 130, each secured to one of the pair of adjacent teeth 50 and extending from proximal end 60 to distal end 70. In another embodiment, each space 140 comprises a single elongate element 130, secured to one of the pair of adjacent teeth 50 and extending from proximal end 60 to distal end 70. In one embodiment, alternate ones of plurality of teeth 50 have secured thereon an elongate element 130 on each side thereof, such that each space 140 is exposed to a single elongate element 130. The operation of treatment apparatus 300 is in all respects similar to the operation of treatment apparatus 10. Advantageously, lice and nits are exposed to maximum heat through the entire length of the respective space 140.

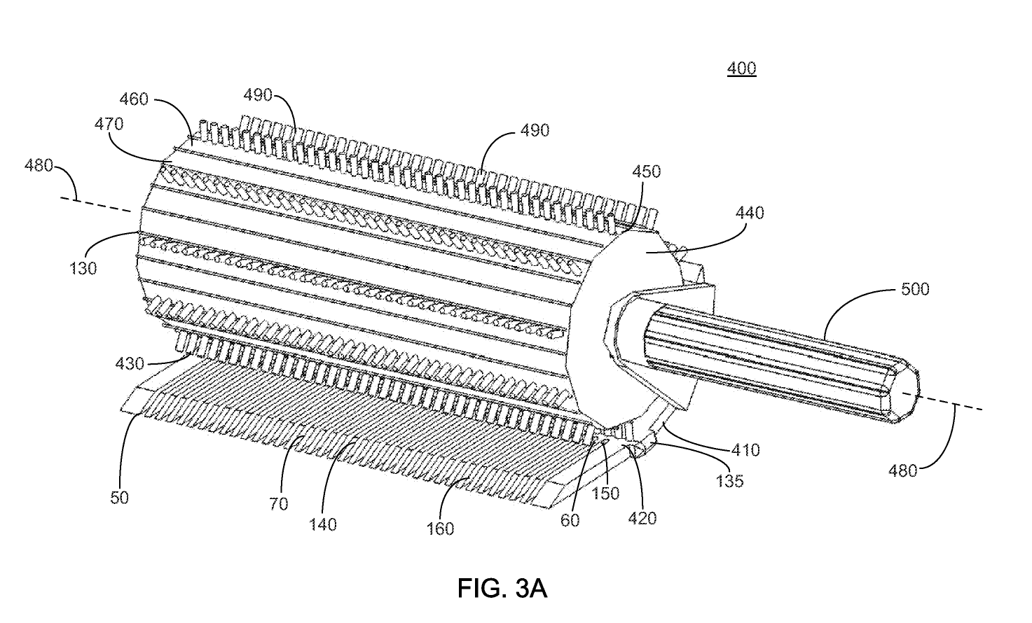

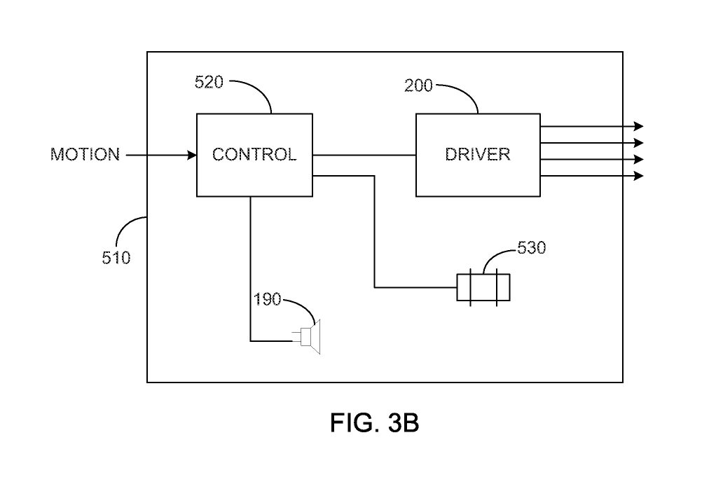

FIG. 3A illustrates a perspective view of a treatment apparatus 400 for hair, comprising: a base member 410, extending from a first end 420 to a second end 430; a plurality of teeth 50 each extending longitudinally from a proximal end 60 to a distal end 70, proximal end 60 of each tooth 50 connected to base member 410; a roller 440 extending from a first end 450 to a second end 460, an outer surface 470 and a central longitudinal axis 480, and further exhibiting a plurality of radially extending projections 490; a plurality of elongate elements 130, each extending across outer surface 470 of roller 440 from first end 450 to second end 460 and radially displaced about outer surface 470; a handle 500; and a motion sensor 135.

Plurality of teeth 50 are disposed across base member 410 from first end 420 to second end 430, thereby forming a comb like assembly. Each adjacent pair of teeth 50 defines a space 140, a proximal end 150 of each space 140 defined by the space between proximal ends 60 of the respective adjacent pair of teeth 50 and a distal end 160 of each space 140 defined by the space between distal ends 70 of the respective adjacent pair of teeth 50. In one non-limiting embodiment, base member 410 extends away from plurality of teeth 50 in a generally concave manner. In one embodiment, elongate elements 130 are evenly spaced about outer surface 470. In one embodiment, plurality of radially extending projections 490 are disposed on outer surface 470 of roller 440 defining uniform linear paths of distinct extensions extending from first end 450 to second 460. In one further embodiment, the linear paths are evenly radially displaced around outer surface 470. In one embodiment, motion sensor 135 is connected anywhere on treatment apparatus 400.

FIG. 3B illustrates a high level schematic diagram of a control unit 510, comprising: a control circuitry 520; a motor 530; a driver 200; and an alarm 190. An output of motion sensor 135 is connected to an input of control circuitry 520. A first output of control circuitry 520 is connected to an input of motor 530 and the shaft of motor 530 is connected to roller 440 (not shown). A second output of control circuitry 520 is connected to the input of driver 200 and each of a plurality of outputs of driver 200 is connected to a respective one of plurality of elongate elements 130. For the sake of clarity, the operation of FIGS. 3A and 3B will be described together.

In operation, control circuitry 520 provides a current through plurality of elongate elements 130 via driver 200, thereby heating up plurality of elongate elements 130 to a temperature of between 60°-250° C. Control circuitry 520 rotates the shaft of motor 530, thereby rotating roller 440. A user holds handle 500 and combs their hair with the comb like assembly of treatment apparatus 400. As the user combs, hair strands enter respective spaces 140 at distal ends 160. As a hair strand nears roller 440, heat from plurality of elongate elements 130 is radiated to the hair strand. As described above, in one embodiment the heat applied to the hair exhibits an energy of 2-20 J/cm². Lice and nits clinging to the hair strand and the surrounding scalp area are killed by the radiated heat from plurality of elongate elements 130. The killed lice and nits are then removed by the comb like assembly during motion of treatment apparatus 400. Lice and nits are killed at a much lower heat than hair is singed, therefore the hair strand is not singed as long as elongate elements 130 are in motion in relation to the hair strand. Advantageously, as roller 440 is rotated, radially extending projections 490 are arranged to raise each hair strand which comes in contact with radially extending projections 490 to a generally upright position, thereby allowing greater exposure of the hair to the radiated heat of plurality of elongate elements 130.

Motion sensor 135 is arranged to detect motion of treatment apparatus 400. In the event the user ceases movement of treatment apparatus 400, motion sensor 135 outputs a signal to control circuitry 520. In one embodiment, alarm 190 indicates that motion has stopped. Responsive to the received signal, control circuitry 520 controls driver 200 to stop current from flowing through plurality of elongate elements 130, thereby ceasing heat radiation and ensuring that hair strands aren't singed. In one embodiment, motion sensor 135 is further arranged to detect the speed of motion of treatment apparatus 400. As the speed increases, control circuitry 520 controls driver 200 to increase the current flowing through elongate elements 130, thereby raising the temperature of the heat output by elongate elements 130 thereby increasing the effectiveness while not singeing the hair. As the speed decreases, control circuitry 520 controls driver 200 to decrease the current flowing through elongate elements 130, thereby lowering the temperature of the heat output by elongate elements 130 and avoiding singeing. As indicated above, lice are killed quicker when exposed to greater temperatures, however the risk of singeing the hair rises with the rise of temperature. Advantageously, the detection of the speed of treatment apparatus 400 allows ideal control of the temperature of the heat output by elongate elements 130 to maximize efficiency of lice killing, while avoiding any injury to the hair or scalp.

In one embodiment, motion sensor 135 is arranged to detect the speed of motion of treatment apparatus 400 and the rotation speed of roller 440 is adjusted such that a hair is completely pulled up by radially extending projections 490 before passing proximal end 150 of the respective space 140. Preferably, the linear speed of the outer circumference of roller 440 is arranged to be greater than the speed of motion of treatment apparatus 400, so as to ensure that hair is drawn in by roller 440. In one embodiment, roller 440 is mechanically rotated by handle 500. The above has been described where treatment apparatus 400 is used for killing and removing lice and nits from human hair, however this is not meant to be limiting in any way. In another embodiment, treatment apparatus 400 can be used for killing and removing lice, fleas and other pests from animal fur.

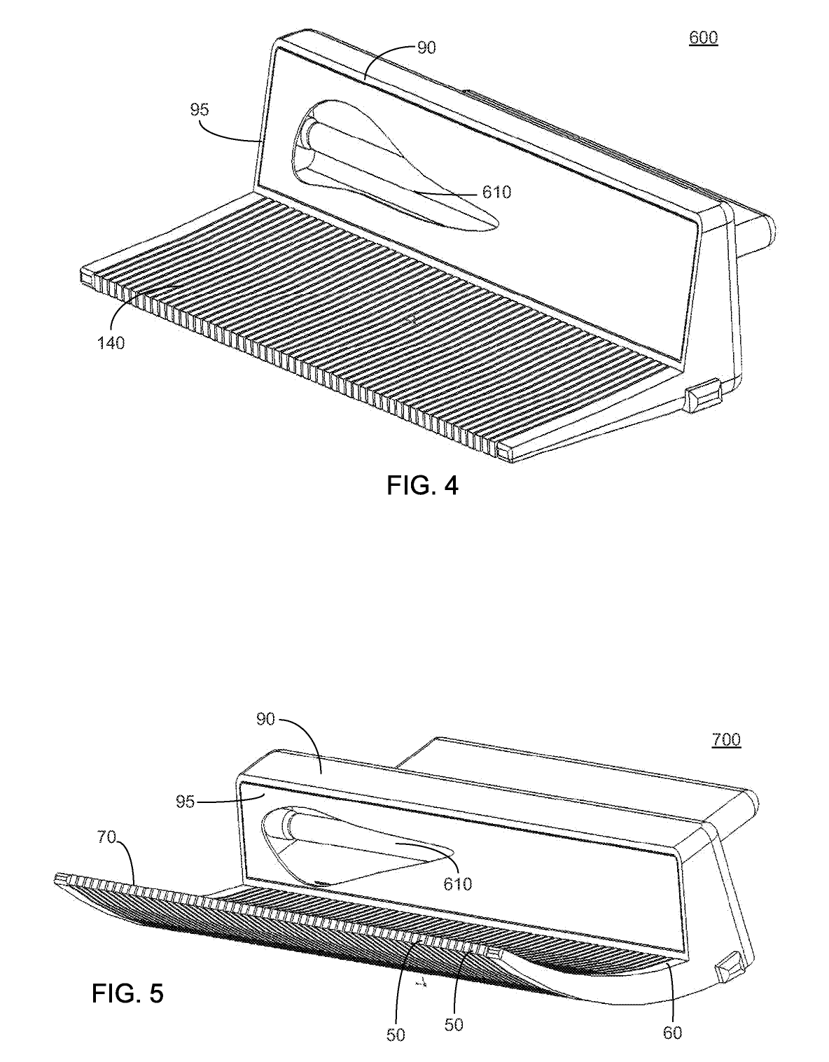

FIG. 4 illustrates a perspective view of a treatment apparatus 600 for hair. Treatment apparatus 600 is in all respects similar to treatment apparatus 10 of FIG. 1A, with the exception that plurality of elongate elements 130 is replaced with a light heat source 610. In one embodiment, light heat source 610 outputs light in the infrared range. In one embodiment, light heat source 610 is disposed external of protrusion member 90, on face 95 (not shown). In another embodiment, as shown, face 95 of protrusion member 90 is composed of a transparent material and light heat source 610 is place internal of protrusion member 90. The transparency of face 95 of protrusion member 90 allows energy from light heat source 610 to exit protrusion member 90 and reach hairs caught in spaces 140. In one embodiment, face 95 of protruding member 90 comprises an optical filter arranged to filter the output light from light heat source 610. In one embodiment, the optical filter is arranged to pass wavelengths between 700-3000 nm and substantially attenuate any wavelengths below 700 nm and above 3000 nm.

FIG. 5 illustrates a perspective view of a treatment apparatus 700 for hair. Treatment apparatus 700 is in all respects similar to treatment apparatus 600 of FIG. 4, with the exception that plurality of teeth 50 extend in a generally concave like manner, from proximal end 60 to distal end 70, in the general direction of the extension of protrusion member 90. The operation of treatment apparatus 700 is in all respects similar to the operation of treatment apparatus 600. Advantageously, the generally concave shape of the comb like assembly of treatment apparatus 700 allows easier control and handling of apparatus 700 during combing of the hair.

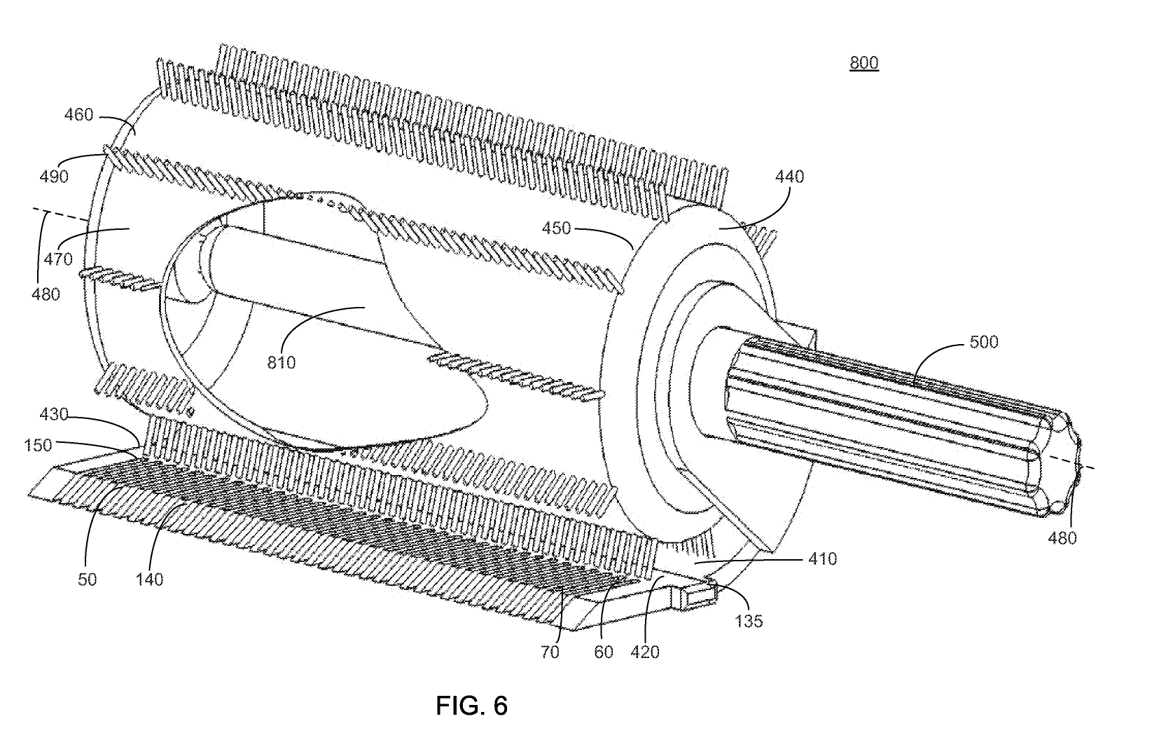

FIG. 6 illustrates a perspective view of a treatment apparatus 800 for hair. Treatment apparatus 800 is in all respects similar to treatment apparatus 400 of FIG. 3 with the exception that plurality of elongate elements 130 is replaced with a light heat source 810. In one embodiment, light heat source 810 outputs light in the infrared range. In one embodiment, light heat source 810 is disposed external of roller 440 (not shown). In another embodiment, as shown, outer surface 470 of roller 440 is composed of a transparent material and light heat source 810 is place internal of roller 440. The transparency of outer surface 470 of roller 440 allows energy from light heat source 810 to exit roller 440 and reach hair strands caught in respective spaces 140. In one embodiment outer surface 470 comprises an optical filter arranged to filter the output light from light heat source 610. In one embodiment, the optical filter is arranged to pass wavelengths between 700-3000 nm and substantially attenuate any wavelengths below 700 nm and above 3000 nm.

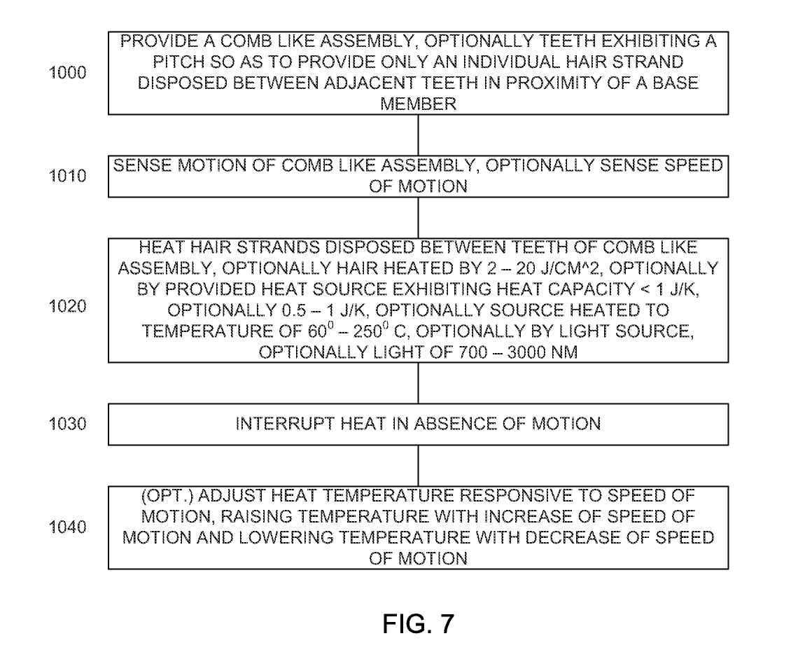

FIG. 7 illustrates a high level flow chart of a first embodiment of a method for hair treatment. In stage 1000, a comb like assembly is provided, as described above in relation to FIGS. 1A, 2A, 4 and 5. Optionally, the provided comb like assembly comprises a plurality of teeth extending from a base member, the teeth exhibiting a pitch so as to provide only an individual strand of hair between adjacent teeth in proximity of the base member. In stage 1010, motion of the comb like assembly of stage 1000, or absence thereof, is sensed by a motion sensor. In one embodiment, the speed of motion of the comb like assembly is further sensed. In stage 1020, a user combs their hair, and the hair strands disposed between the teeth of the comb like assembly are heated by a heat source. In one embodiment, the hair strands disposed between the teeth of the comb like assembly are heated by an element exhibiting a temperature of 60°-250° C. In one embodiment, the heat applied to the hair exhibits an energy of 2-20 J/cm². In one embodiment, the heat source comprises an elongate element, as described above. In one embodiment, the heat source exhibits a heat capacity of less than 1 J/K. In one further embodiment, the heat source exhibits a heat capacity of 0.5-1 J/K. In another embodiment, the heat source comprises a light heat source arranged to output light in the infrared range. In one further embodiment, the hair strands are irradiated by light comprising wavelengths of 700-3000 nm output by the light heat source. In stage 1030, if absence of motion is sensed in stage 1010 of the comb like assembly, the heating of the hair strands is interrupted. In optional stage 1040, the temperature of the heating of stage 1020 is adjusted responsive to the optionally sensed speed of motion of stage 1010. In one embodiment, the temperature of the heating of stage 1020 is raised responsive to an increase in the speed of motion of the comb like assembly and the temperature of the heating of stage 1020 is lowered responsive to a decrease in the speed of motion of the motion of the comb like assembly.

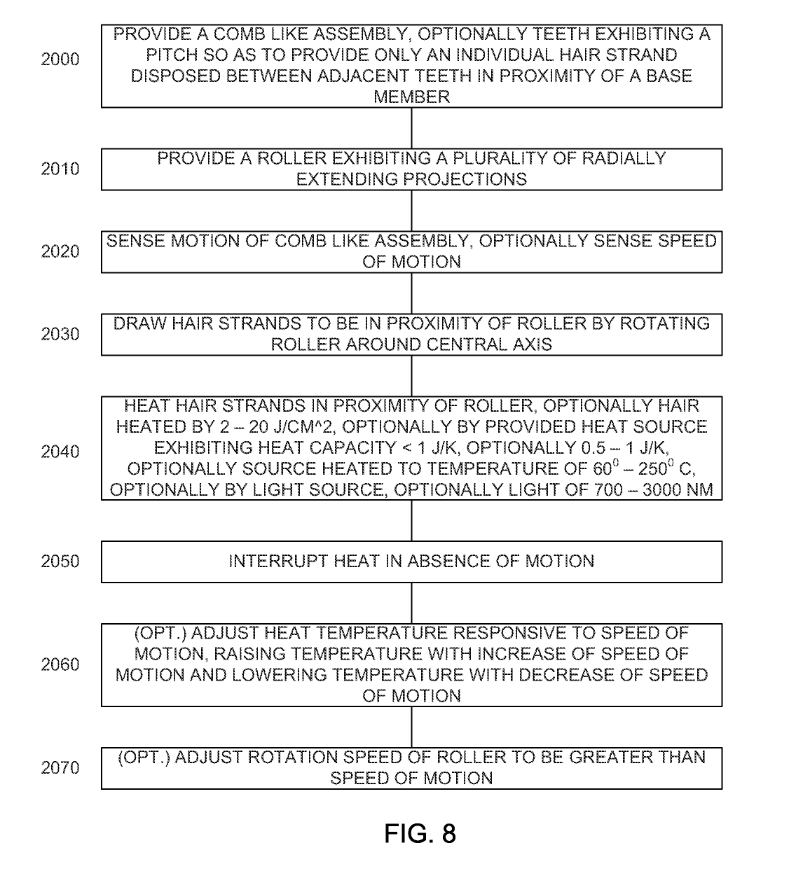

FIG. 8 illustrates a high level flow chart of a second embodiment of a method for hair treatment. In stage 2000, a comb like assembly is provided, as described above in relation to FIGS. 3A and 6. Optionally, the provided comb like assembly comprises a plurality of teeth extending from a base member, the teeth exhibiting a pitch so as to provide only an individual strand of hair between adjacent teeth in proximity of the base member. In stage 2010, a roller exhibiting a plurality of radially extending projections is provided in proximity with the comb like assembly of stage 2000. In stage 2020, motion of the comb like assembly of stage 2000, or absence thereof, is sensed by a motion sensor. In one embodiment, the speed of motion of the comb like assembly is further sensed. In stage 2030, a user combs their hair. The roller of stage 2010 is rotated around a central longitudinal axis, thereby the hair strands disposed between the teeth of the comb like assembly are drawn by the plurality of radially extending projections to be in proximity of the roller. In stage 2040, the hair strands drawn to be in proximity of the roller are heated by a heat source. In one embodiment, the hair strands in proximity of the roller are heated by an element exhibiting a temperature of 60°-250° C. In one embodiment, the heat applied to the hair exhibits an energy of 2-20 J/cm². In one embodiment, the heat source comprises an elongate element, as described above. In one embodiment, the heat source exhibits a heat capacity of less than 1 J/K. In one further embodiment, the heat source exhibits a heat capacity of 0.5-1 J/K. In another embodiment, the heat source comprises a light heat source arranged to output light in the infrared range. In one further embodiment, the hair strands are irradiated by light comprising wavelengths of 700-3000 nm output by the light heat source.

In stage 2050, if absence of motion is sensed in stage 2020 of the comb like assembly, the heating of the hair strands is interrupted. In optional stage 2060, the temperature of the heating of stage 2040 is adjusted responsive to the optionally sensed speed of motion of stage 2020. In one embodiment, the temperature of the heating of stage 2040 is raised responsive to an increase in the speed of motion of the comb like assembly and the temperature of the heating of stage 2040 is lowered responsive to a decrease in the speed of motion of the motion of the comb like assembly. In optional stage 2070, the speed of rotation of the roller of stage 2030 is adjusted so that the linear speed of the outer circumference of the roller of stage 2030 is greater than the sensed speed of motion of the comb like assembly of stage 2020 so as to draw hair in to the comb like assembly.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination. In the claims of this application and in the description of the invention, except where the context requires otherwise due to express language or necessary implication, the word “comprise” or variations such as “comprises” or “comprising” is used in any inclusive sense, i.e. to specify the presence of the stated features but not to preclude the presence or addition of further features in various embodiments of the invention.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting. No admission is made that any reference constitutes prior art. The discussion of the reference states what their author's assert, and the applicants reserve the right to challenge the accuracy and pertinency of the cited documents. It will be clearly understood that, although a number of prior art complications are referred to herein, this reference does not constitute an admission that any of these documents forms part of the common general knowledge in the art in any country.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

1. A treatment apparatus for hair comprising:
a comb like assembly comprising a base member and a plurality of teeth extending from said base member;
a motion sensor fixed in relation to said comb like assembly and arranged to output a signal indicative of motion of said comb like assembly;
a control circuitry in communication with said motion sensor; and
a heat source arranged to provide heat to hair strands disposed between said plurality of teeth of said comb like assembly,
wherein said control circuitry is arranged to interrupt said heat source in the absence of motion of said comb like assembly.

2. The treatment apparatus according to claim 1, wherein said heat source comprises an element arranged to provide the heat to the hair strands, said element heated to a temperature of between 60 degrees Centigrade and 250 degrees Centigrade.

3. The treatment apparatus according to claim 1, wherein said heat source comprises an element which exhibits a heat capacity of less than 1 Joule per Kelvin.

4. The treatment apparatus according to claim 1, wherein said heat source comprises an element which exhibits a heat capacity of 0.5-1 Joule per Kelvin.

5. The treatment apparatus according to claim 2, wherein said element is an elongate element secured to said base member.

6. The treatment apparatus according to claim 2, wherein said element is an elongate element secured to said base member and arranged to proceed generally orthogonally to the extension of said plurality of teeth.

7. The treatment apparatus according to claim 2, wherein said element is secured to said plurality of teeth.

8. The treatment apparatus according to claim 2, wherein said heat source comprises a plurality of said elements, secured along a side of alternate ones of said plurality of teeth.

9. The treatment apparatus according to claim 2, wherein said element is secured along a side of each of the plurality of teeth.

10. The treatment apparatus according to claim 1, wherein said heat source comprises an infrared lamp secured in relation to said base member.

11. The treatment apparatus according to claim 10, wherein said infrared lamp is arranged to output light exhibiting wavelengths of 700-3000 nanometers.

12. The treatment apparatus according to claim 1, wherein said plurality of teeth are curved to a generally concave shape.

13. The treatment apparatus according to claim 1, wherein said plurality of teeth exhibit a pitch so as to provide only an individual hair strand disposed between adjacent teeth of said comb like assembly in proximity of said base member.

14. The treatment apparatus according to claim 1, further comprising a roller in a fixed relationship to said base member, said roller comprising a plurality of radially extending projections arranged to draw the hair strands to be in proximity to said roller when said roller is rotated about a central longitudinal axis thereof.

15. The treatment apparatus according to claim 14, further comprising a motor in communication with said roller, and arranged to rotate said roller about the central longitudinal axis thereof.

16. The treatment apparatus according to claim 15, wherein said motor is responsive to said control circuitry, said control circuitry arranged to control said motor to rotate said roller so that the outer circumference of said roller exhibits a linear speed greater than the speed of motion detected by said motion sensor.

17. The treatment apparatus according to claim 1, wherein said motion sensor is further arranged to output a signal indicative of the speed of motion of said comb like assembly and wherein said control circuitry is further arranged to:
in the event the speed of motion of said comb like assembly increases, raise the temperature of the heat output of said heat source; and
in the event the speed of motion of said comb like assembly decreases, lower the temperature of the heat output of said heat source.

18. A method of treating an infested hair portion comprising:
providing a comb like assembly comprising a base member and a plurality of teeth extending from said base member;
sensing motion of said provided comb like assembly;
heating hair strands disposed between the plurality of teeth of said provided comb like assembly; and
interrupting said heating in the absence of said sensed motion.

19. The method according to claim 18, wherein said heating hair strands comprises:
providing an element; and
heating said provided element to a temperature of between 60 degrees Centigrade and 250 degrees Centigrade.

20. The method according to claim 19, wherein said provided element exhibits a heat capacity of less than 1 Joule per Kelvin.

21. The method according to claim 19, wherein said provided element exhibits a heat capacity of 0.5-1 Joule per Kelvin.

22. The method according to claim 19, wherein said provided element is an elongate element secured along a side of at least one of the plurality of teeth.

23. The method according to claim 19, wherein said provided element is an elongate element secured to said base member.

24. The method according to claim 18, further comprising:
providing an infrared lamp, wherein said heating hair strands is responsive to said provided infrared lamp.

25. The method according to claim 24, wherein said heating hair strands comprises outputting light from said provided infrared lamp, said output light exhibiting wavelengths of 700-3000 nanometers.

26. The method according to claim 18, wherein said plurality of teeth exhibit a pitch so as to provide only an individual hair strand disposed between adjacent teeth of said comb like assembly in proximity of the base member.

27. The method according to claim 18, further comprising:
providing a roller comprising a plurality of radially extending projections; and
drawing the hair strands to be in proximity of said provided roller by rotating said provided roller about a central longitudinal axis thereof.

28. The method according to claim 27, wherein said rotating is at a speed such that the outer circumference of said provided roller exhibits a linear speed greater than said sensed motion of said provided comb like assembly.

29. The method according to claim 18, further comprising:
sensing the speed of motion of said provided comb like assembly;
in the event the speed of motion of said comb like assembly increases, raising the temperature of said heating; and
in the event the speed of motion of said comb like assembly decreases, lowering the temperature of said heating.
